(19) United States
(12) Patent Application Publication
(10) Pub. No.: US 2018/0352059 A1
(43) Pub. Date: Dec. 6, 2018

(54) Phone Storage Device

(71) Applicants: Jeff McSweeny, Brighton, MA (US); Luke Capritti, Chesterfield, NJ (US)

(72) Inventors: Jeff McSweeny, Brighton, MA (US); Luke Capritti, Chesterfield, NJ (US)

(21) Appl. No.: 15/613,087

(22) Filed: Jun. 2, 2017

(51) Int. Cl. H04M 1/02; H04B 1/3888

(52) U.S. Cl. CPC H04M 1/026; H04B 1/3888

(57) ABSTRACT

The present invention relates to the cellular phone accessory industry. The disclosure as detailed herein is in the technical field of media device accessories. More specifically, the present disclosure relates to the technical field of cellular phone accessories. Even more specifically, the present disclosure relates to the technical field of storage for cellular phone accessories. Often a user of a cell phone wishes to use headphones with the cellular phone. However, there is not always a convenient or easily accessible place to store the headphones when not in use. Accordingly, a user must use a separate carrying case or other holder to store the headphones, or other accessory while not in use. The invention is a case which wraps around the mobile phone and allows the headphones or other accessory to be stored with the phone. The present invention is a case which wraps around and is removably secured to a cellular phone that also has a holder for headphones or other accessories. In addition, there is a power component that allows for the charging of the cellular device to which the case is attached.

### CROSS REFERENCE TO RELATED APPLICATIONS

Not applicable.

### REFERENCE TO GOVERNMENT FUNDING SOURCES

Not applicable.

### REFERENCE TO SEQUENCE LISTING

Not applicable.

### FIELDS OF THE INVENTION

The present invention relates to the cellular phone accessory industry. The disclosure as detailed herein is in the technical field of media device accessories. More specifically, the present disclosure relates to the technical field of cellular phone accessories. Even more specifically, the present disclosure relates to the technical field of storage for cellular phone accessories.

### BACKGROUND OF THE INVENTION

Often a user of a cell phone wishes to use headphones with the cellular phone. However, there is not always a convenient or easily accessible place to store the headphones when not in use. Accordingly, a user must use a separate carrying case or other holder to store the headphones, or other accessory while not in use. The invention is a case which wraps around the mobile phone and allows the headphones or other accessory to be stored with the phone.

### GENERAL SUMMARY OF THE INVENTION

The present invention is a case which wraps around and is removably secured to a cellular phone that also has a holder for headphones or other accessories. In addition, there is a power component that allows for the charging of the cellular device to which the case is attached.

### DESCRIPTION OF FIGURES

FIG. 1 is a perspective view, which shows a perspective view of the face component and edge components and their subcomponents.

FIG. 2 is a perspective view, which shows a side perspective view of the edge component.

FIG. 3 is a perspective view, which shows an opposite side perspective view of the edge component.

FIG. 4 is a perspective view, which shows a top down perspective view of media storage device as may be seen by a user.

FIG. 5 is a perspective view, which shows a bottom perspective view of the media storage device.

FIG. 6 is a perspective view, which shows a side perspective view of grasping components.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way.

One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations.

Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions.

Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order.

The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

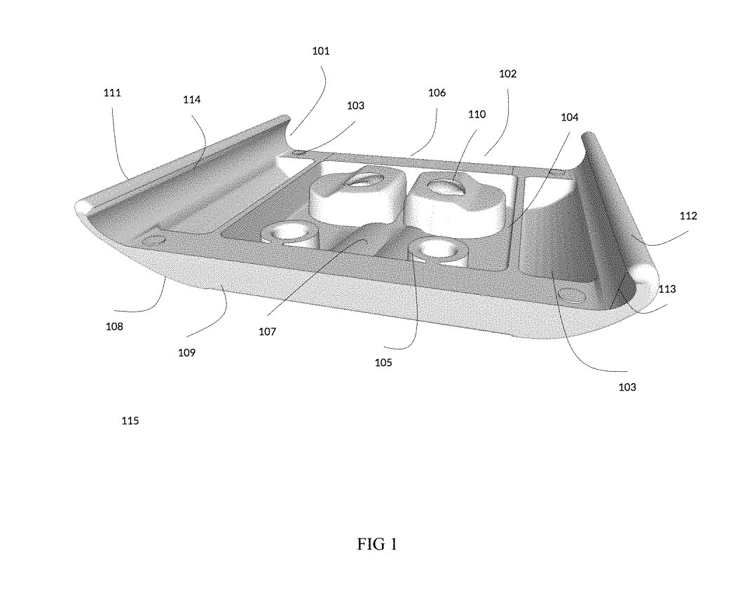

Referring now to FIG. 1, which shows a perspective view of the face component and edge components and their subcomponents.

Media storage device 115 comprises an attachment that may be combined with one or more other media device to operably attach to a media device and provide storage for one or more storage item. Media storage device 115 has an alternative embodiment herein termed “inflatable phone storage device”. Media storage device 115 preferably comprises face component 102, edge component 101, and finally, charging component.

Edge component 101 comprises the main region of the media storage device 115 that mediates attachment to the media device. Spatially, edge component 101 is preferably positioned lateral to the face component 102 and on the edges of the media device. Edge component 101 preferably comprises structural grasping component 111.

Face component 102 comprises a component of the media storage device 115 that is situated on the media device back side that allows storage of one or more storage item. Spatially, face component 102 is preferably positioned on the back of the media device. Face component 102 is mainly thought to be composed of Neoprene rubber, however other embodiments may be composed of any of the following: rubber, PLA plastic, ABS plastic, plastic, polyethylene, or polypropylene.

In some embodiments, the width of face component 102 can be calculated by the maximum size of the media device width. In some embodiments, the width of face component 102 can be calculated by the minimum size of the media device width.

In some embodiments, face component 102 has a preferred height of 60 millimeters but in some embodiments, may range from a minimum of 20 millimeters to a maximum height of 300 millimeters. In some embodiments, the height of face component 102 can be calculated by that which will fit a storage item. In some embodiments, the height of face component 102 can be calculated by that which will encompass the size of the media device.

In some embodiments, face component 102 has a preferred depth of 18 millimeters but in some embodiments, may range from a minimum of 10 millimeters to a maximum depth of 80 millimeters.

Face component 102 has multiple alternative embodiments herein termed a “front facing face component” embodiment, a “web capture component” embodiment, and a “full media device size” embodiment. Face component 102 preferably comprises ancillary storage region 103, main storage region 106, securing component 105, bottom interaction face 109, outward component face 402, and finally, top interaction face 302.

Ancillary storage region 103 comprises a side region of the face component 102 that may act as a place for extra components or mediate flexibility. In some embodiments, it is thought that if ancillary storage region 103 is absent, then the main storage region 106 may directly interact with the edge component 101. Ancillary storage region 103 preferably comprises grasping region 108.

Item specific storage compartment 104 comprises a storage area specifically molded to the storage item that is to be used with the media storage device 115. Spatially, item specific storage compartment 104 is preferably positioned within the main storage region 106. Item specific storage compartment 104 comprises secondary recess 107 and main recess 110.

Securing component 105 comprises a means for securing the storage item if the item specific storage compartment 104 is not holding the storage item via physical means. In some embodiments, it is thought that examples of securing component 105 may include: magnets, a strap, or closing doors. In some embodiments, it is thought that if securing component 105 is absent, then it may be secured by the shape of the item specific storage compartment 104. In other instances, if securing component 105 is absent, then it may by secured by the shape itself, a strap, or closing doors.

Main storage region 106 comprises the main storage item component space where a storage item would otherwise be removably contained within the media storage device 115. Main storage region 106 is preferably positioned central to the edge component 101, below the top interaction face 302, and above the bottom interaction face 109. Main storage region 106 preferably comprises item specific storage compartment 104.

Secondary recess 107 comprises a recess that is to accommodate the antenna or cord related shape of one or more earbuds.

Grasping region 108 comprises the phone grasping region, which is smooth so that it can fit in and out of a pocket.

Bottom interaction face 109 comprises a top angled face of the face component 102 that may have one or more interactive components. Bottom interaction face 109 preferably comprises bottom interaction face angle 201.

Main recess 110 comprises a recess that is to accommodate the audio speaker related shape of one or more earbuds.

Structural grasping component 111 comprises a means for grasping the media device such that it is reversibly affixed and is still able to maintain storage item within the face component 102. In some embodiments, it is thought that an example of structural grasping component 111 may include a bendable wing as in the grasping region 108 and the like. Structural grasping component 111 has multiple alternative embodiments herein termed an “adhesive based component” embodiment, a “magnet based component” embodiment, and a “suction based component” embodiment. Structural grasping component 111 preferably comprises edge grasping wing 112.

Edge grasping wing 112 comprises a protrusion from the structural grasping component 111 that is used to grasp the edges of the media device. In some embodiments, edge grasping wing 112 has a preferred thickness of 4 millimeters but in some embodiments, may range from a minimum of 1 millimeter to a maximum thickness of 13 millimeters. In some embodiments, the thickness of edge grasping wing 112 can be calculated by the specific strength of a given material.

If edge grasping wing 112 is absent, it is thought that that there are alternatives. For example, if absent, then materials or shapes can be changed to otherwise adhere on the edges of the media device. Further, it is possible that in its absence, then it can be replaced by other components. Finally, if absent, then materials, molding, shape can be changed to allow it to store more things. Edge grasping wing 112 has an alternative embodiment herein termed “fat middle with skinny outsides”. Edge grasping wing 112 comprises edge grasping distance 113 and interior grasping wing edge 114.

Edge grasping distance 113 comprises the length from the back of the face component 102 to the apical tip of the interior grasping wing edge 114. In some embodiments, edge grasping distance 113 has a preferred length of 10 millimeters but in some embodiments, may range from a minimum of 6 millimeters to a maximum length of 20 millimeters.

Interior grasping wing edge 114 comprises the edge of the edge grasping wing 112 that is superimposed on the opposite side of the media device allowing for attachment. In some embodiments, interior grasping wing edge 114 has a preferred contact angle of 140 degrees but in some embodiments, may range from a minimum of 90 degrees to a maximum contact angle of 180 degrees.

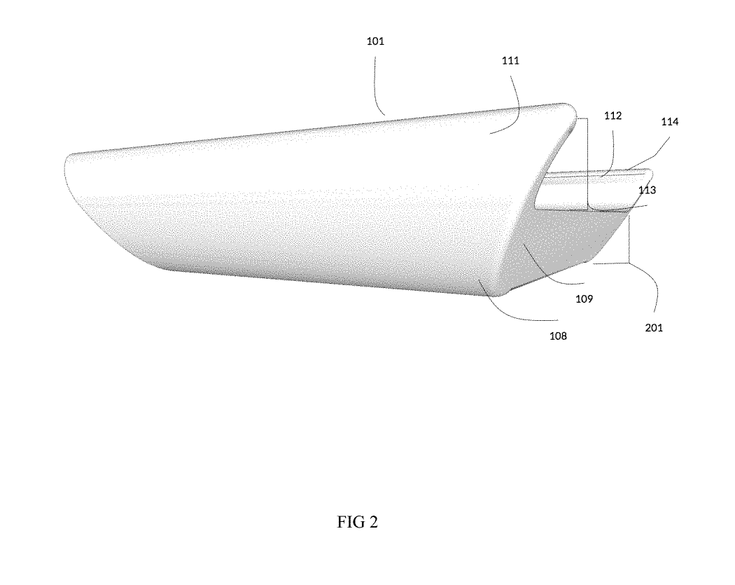

Referring now to FIG. 2, which shows a side perspective view of the edge component.

In some embodiments, bottom interaction face angle 201 has a preferred angle of 45 degrees but in some embodiments, may range from a minimum of 20 degrees to a maximum angle of 60 degrees. Bottom interaction face angle 201 functions to both 1) have an angle that is comparable for the use of the particular media device and to 2) allow a person to put the media storage device 115 into one's pocket, etc., but prevent the media storage device 115 from being caught on an edge and sliding off of the media device. Bottom interaction face angle 201 has an alternative embodiment herein termed “bottom face 90 degree angle”.

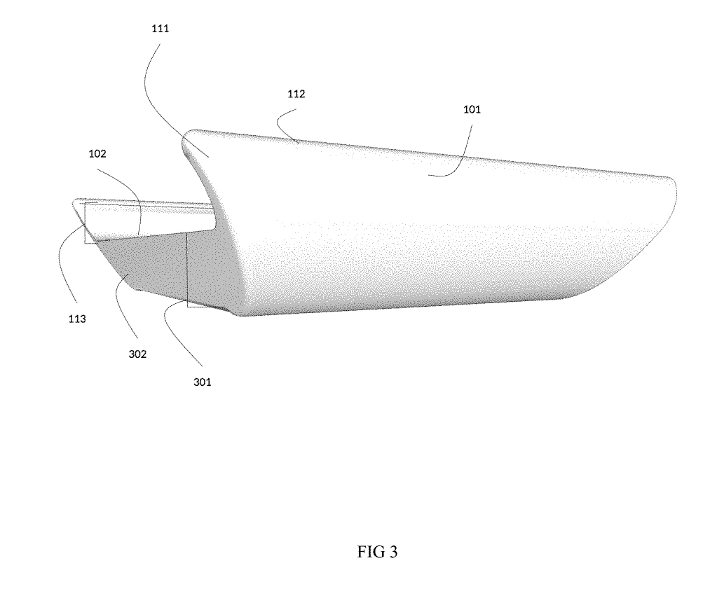

Referring now to FIG. 3, which shows an opposite side perspective view of the edge component.

In some embodiments, top interaction face angle 301 has a preferred angle of 45 degrees but in some embodiments, may range from a minimum of 20 degrees to a maximum angle of 60 degrees. Top interaction face angle 301 has many purposes which are as follows: first, the purpose of top interaction face angle 301 is to have an angle that is comparable for the purpose of using the particular media device. Next, it serves to allow a person to put the media storage device 115 into one's pocket, etc., but prevent the media storage device 115 from being caught on an edge and sliding off of the media device. Lastly, top interaction face angle 301 serves to not be perpendicular for interactions that may occur because then the component would slide off. Top interaction face angle 301 has an alternative embodiment herein termed “90 degree angle”. Top interaction face 302 comprises a top face of the face component 102 that may have one or more interactive components. Top interaction face 302 preferably comprises top interaction face angle 301.

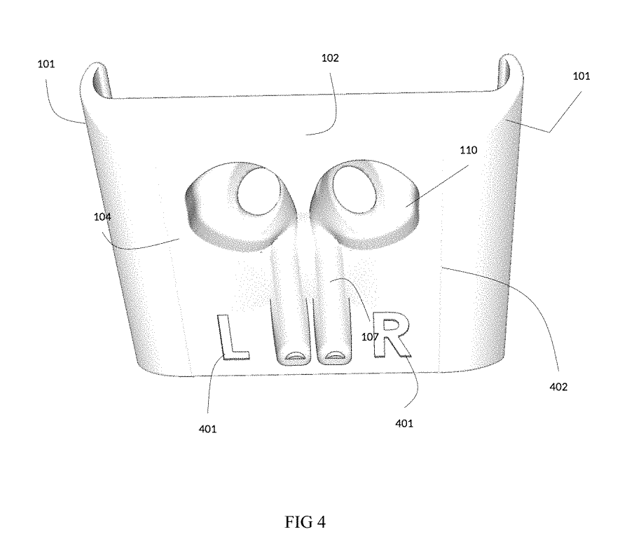

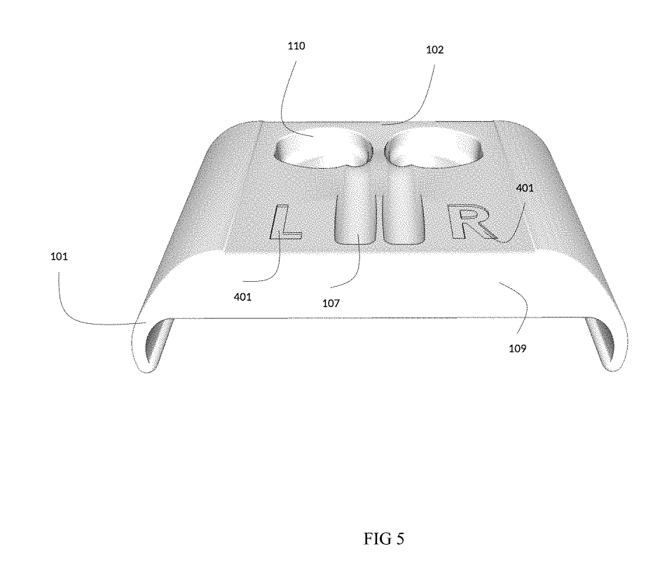

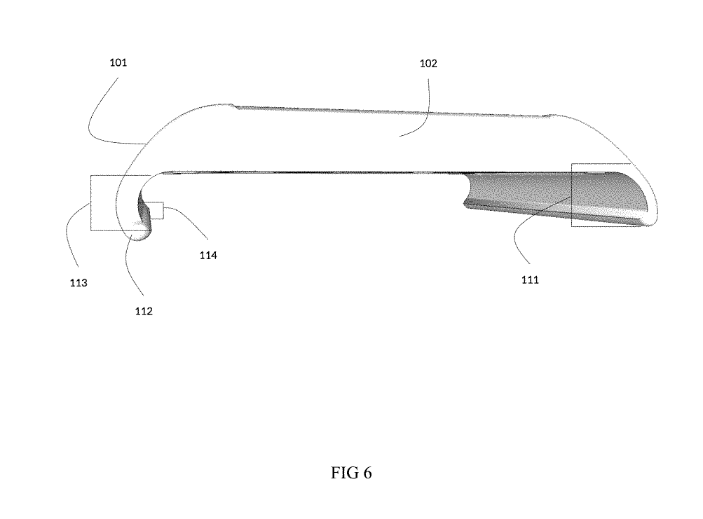

Referring now to FIG. 4, which shows a top down perspective view of media storage device as may be seen by a user; FIG. 5, which shows a bottom perspective view of the media storage device; and FIG. 6, which shows a side perspective view of grasping components.

Indicia 401 comprises a markers or indicia on the outward component face 402 that indicate information relevant to use of the components within the main storage region 106.

Spatially, outward component face 402 is preferably positioned parallel to the media device and outside the main storage region 106. Outward component face 402 preferably comprises indicia 401.

The following elements: media device, storage item, “front facing face component” embodiment, charging component, power source, “web capture component” embodiment, “adhesive based component” embodiment, “magnet based component” embodiment, “suction based component” embodiment, “inflatable phone storage device” embodiment, “90 degree angle” embodiment, “full media device size” embodiment, “fat middle with skinny outsides” embodiment, and “bottom face 90 degree angle” embodiment are important for the working functionality, but do not appear in the drawings and are shown below.

Media device comprises an electronic device that presents content to a user. In some embodiments, it is thought that an example of a media device could be a phone or perhaps a tablet and the like.

Storage item comprises an item that is used by a consumer of a media device that can be stored within a media storage device 115. In some embodiments, it is thought that examples of storage item may include: ear buds, a battery, money coins, money, sunglasses, or a credit card.

“Front facing face component” embodiment comprises an embodiment of the media storage device 115 wherein the face component 102 is positioned on the front of the media device, where it may be most protective for your glass.

Charging component comprises a device used to put energy into a secondary cell or rechargeable battery by forcing an electric current through it. In some embodiments, it is thought that examples of charging component may include: a resonance induction second half, a battery, USB, corded peripheral power, DC power, AC power, or wireless. In some embodiments, it is thought that if charging component is absent, then the media storage device 115 may use only the face component 102 and edge component 101 and still work. Charging component preferably comprises power source.

Power source comprises a source of electrical energy. In some embodiments, it is thought that an example of power source could be a solar power source or perhaps a QI charging source and the like.

“Web capture component” embodiment comprises a web styled face component 102 made of elastic material that can hold one or more storage item.

“Adhesive based component” embodiment comprises an embodiment of the structural grasping component 111 wherein the mediation of the grasping is formed by an adhesive.

“Magnet based component” embodiment comprises an embodiment of the structural grasping component 111 wherein the mediation of the grasping is formed by magnets.

“Suction based component” embodiment comprises an embodiment of the structural grasping component 111 wherein the mediation of the grasping is formed by a suction based mechanism.

“Inflatable phone storage device” embodiment comprises an embodiment of the media storage device 115 where it is inflatable and deflatable.

“90 degree angle” embodiment comprises an embodiment where the top interaction face 302 is perpendicular to the flat plane of the media device.

“Full media device size” embodiment comprises an embodiment of the face component 102 that wraps the entire size of the media device.

“Fat middle with skinny outsides” embodiment comprises an embodiment of the edge grasping wing 112 wherein the middle is thicker and the outside is thinner.

“Bottom face 90 degree angle” embodiment comprises an embodiment where the bottom interaction face 109 is perpendicular to the flat plane of the media device.

1. A media storage device comprising:
a. a face component with a height ranging from 20 mm to 300 mm and a depth ranging from 10 mm to 80 mm wherein the face component further comprises:
i. a top interaction face, wherein the top interaction face further comprises a top interaction face angle,
ii. an ancillary storage region, wherein the ancillary storage region further comprises a grasping region,
iii. an outward component face,
iv. a main storage region,
v. a bottom interaction face, wherein the bottom interaction face further comprises a bottom interaction face angle, and
vi. a securing component,
b. an edge component; and
c. a charging component.

2. (canceled)

3. The device of claim 1 wherein the charging component further comprises a power source.

4. The device of claim 1 wherein the bottom interaction face angle ranges from 20 degrees to a maximum of 60 degrees.

5. The device of claim 1 wherein the top interaction face angle ranges from 20 degrees to a maximum of 60 degrees,

6. The device of claim 1 wherein the main storage region further comprises an item specific storage compartment, where the item specific storage compartment further comprises:
a. a secondary recess; and
b. a main recess.

7. A media storage device comprising:
a. a face component,
b. an edge component, wherein the edge component further comprises:
i. a structural grasping component wherein the structural grasping component further comprises an edge grasping wing wherein the edge grasping wing wire has a thickness ranging from 4 mm to 13 mm, wherein the edge grasping wing further comprises:
1. an interior grasping wing edge; and
2. an edge grasping distance; and
c. a charging component.

8. The device of claim 7 wherein the charging component further comprises a power source.

9. (canceled)

10. (canceled)

11. The device of claim 7 wherein the interior grasping wing edge has a contact angle ranging from 90 degrees to 180 degrees.

12. The device of claim 7 wherein the edge grasping distance has a length ranging from 6 mm to 20 mm.

13. A media storage device comprising:
a. a face component wherein the face component further comprises:
i. a top interaction face, wherein the top interaction face further comprises a top interaction face angle,
ii. an ancillary storage region, wherein the ancillary storage region further comprises a grasping region,
iii. an outward component face,
iv. a main storage region,
v. a bottom interaction face, wherein the bottom interaction face further comprises a bottom interaction face angle, and
vi. a securing component,
b. an edge component wherein the edge component further comprises:
i. a structural grasping component wherein the edge grasping wing wire has a thickness ranging from 4 mm to 13 mm; and
c. a charging component wherein the charging component further comprises a power source.

14. The device of claim 13 wherein the bottom interaction face angle and top interaction face angles range from 20 degrees to a maximum of 60 degrees.

15. (canceled)

16. The device of claim 13 wherein the interior grasping wing edge has a contact angle ranging from 90 degrees to 180 degrees.

17. The device of claim 13 wherein the edge grasping distance has a length ranging from 6 mm to 20 mm.

18. The device of claim 13 wherein the face component has a height ranging from 20 mm to 300 mm and a depth ranging from 10 mm to 80 mm.
